(19) United States
(12) Patent Application Publication
(10) Pub. No.: US 2005/0249634 A1
(43) Pub. Date: Nov. 10, 2005

(54) Calibration solution system for use in an automatic clinical analyzer

(76) Inventor: William Jackson Devlin SR., Lincoln University, PA (US)

Correspondence Address: DADE BEHRING INC.;LEGAL DEPARTMENT, 1717 DEERFIELD ROAD, DEERFIELD, IL, 60015, US

(21) Appl. No.: 10/842,668

(22) Filed: May 10, 2004

(51) Int. Cl. G01N 35/00

(52) U.S. Cl. 422/64

(57) ABSTRACT

A biochemical analyzer adapted to automatically perform calibration and quality control protocols using shuttles adapted to remove calibration and quality control solution vials from a loading tray and to inventory said solution vials on board the biochemical analyzer in a calibration and quality control solution server. In addition, the analyzer is adapted to automatically penetrate the closure covering the opening of the calibration and quality control solution vials, aspirate an amount of solution therefrom and dispense said solution into a test cuvette, thereby eliminating the previous need for operator intervention.

### FIELD OF THE INVENTION

The present invention relates to an apparatus for automatically analyzing a patient's biological fluids such as urine, blood serum, plasma, cerebrospinal fluid and the like. More particularly, the present invention relates to a method for automating the processes involved in performing quality control procedures within an automated biochemical analyzer adapted for analyzing biological fluids.

### BACKGROUND OF THE INVENTION

An increasing number of analytical assays related to patient diagnosis and therapy can be performed by automated biochemical analyzers using a sample of a patient's infections, bodily fluids or abscesses. Generally, such biochemical analyzers employ a combination of analyte specific chemical reagents and reaction monitoring means to assay or determine the presence or concentration of a specific substance or analyte within a liquid sample suspected of containing that particular analyte. Patient samples are typically placed in tube-like vials, extracted from the vials, combined with various reagents in special reaction cuvettes, incubated, and analyzed to aid in treatment of the patient. In typical clinical biochemical analyzers, one or more assay reagents are added at separate times to a liquid sample, the sample-reagent solution is mixed and incubated within a reaction cuvette. Analytical measurements using a beam of interrogating radiation interacting with the sample-reagent solution, for example turbidimetric or fluorometric or absorption readings or the like, are made to ascertain end-point or rate values from which the amount of analyte may be determined.

Automated biochemical analyzers are well known and almost universally employ some sort of a calibration curve that relates analyte concentration within a carefully prepared solution having a known analyte concentration against the signal generated by the reaction monitoring means in response to the presence of the analyte. Such solutions are called “calibrators” or “calibration solutions” or “standard solutions” and are contained in tube-like vials closed with a stopper of some sort. It is regular practice within the biochemical analytical industry to establish a full calibration curve for a chemical analyzer by using multiple calibration solutions which have been carefully prepared with known, predetermined varying concentrations of analyte. These calibration solutions are assayed one or more times and the resulting reaction signals are plotted versus their respective known analyte concentrations. A continuous calibration curve is then produced using any of several mathematical techniques chosen to produce an accurate replication of the relationship between a reaction signal and the analyte concentration. The shape of the calibration curve is affected by a complex interaction between reagents, analyte and the analyzer's electromechanical design. Thus, even if the theoretical analyte-reagent reaction is known, it is generally necessary to employ mathematical techniques to obtain an acceptable calibration curve. The range of analyte concentrations used in establishing a full calibration curve is typically chosen to extend below and beyond the range of analyte concentrations expected to be found within biological samples like blood, serum, plasma, urine and the like. Herein, the term “calibration solution” also encompasses so-called “quality control” solutions typically having a zero-level and a high-level of analyte used to confirm proper analyzer operation but not to calibrate same.

Due to increasing pressures on clinical laboratories to reduce cost-per-reportable result, there continues to be a need for improvements in the overall cost performance of automated biochemical analyzers. In particular, the necessity for operator involvement in conducting routine analyzer calibration protocols needs to be minimized in order to reduce overall operating expenses. A positive contributor to minimizing operator involvement is the ability to automatically provide a continuous supply of calibration solutions as required to perform a wide range of analyzer calibration protocols.

Problematically, current procedures employed in the industry for calibrating an analyzer require an operator to retrieve vial containing the requisite calibration solutions from a refrigerated area, open the closed vial or the like, typically by unscrewing a cap or removing a stopper, aspirating a portion of the calibration solution, possibly preparing diluted solutions to provide a range of analyte concentrations, and dispensing some or all of several calibration solutions into a test cuvette. In certain instances, calibration solutions have an undesirably short useful life time during which the solution remains stable and thus are supplied in a more stable powdered form rather than in a less stable liquid form. Prior to being used, a vial containing a powdered or lyophilized calibration solution is opened by an operator, rehydrated using a precise amount of distilled or de-ionized water, the vial is re-closed, shaken to dissolve all lyophilized calibrator before aspirating a portion of the calibration solution. The contents of the test cuvette are then assayed by the analyzer and the results used to either confirm that the analyzer is in proper calibration condition or the results may be used to adjust the analyzer's calibration curves to achieve a proper calibration condition.

### SUMMARY OF THE INVENTION

The object of the present invention is to provide a random access biochemical analyzer adapted to determine when and which calibration solutions need to be evaluated by the analyzer and to automatically perform calibration and quality control protocols and make adjustments as required to maintain the analyzer in a proper and accurate analyzing condition. A calibration solution vial supply system important to the present invention employs container shuttles adapted to remove calibration solution vials from a loading tray and to inventory said solution vials on board the biochemical analyzer in a calibration solution server. In addition, the analyzer is adapted to automatically penetrate the closure covering the opening of the calibration solution vials, aspirate an amount of solution and dispense said solution into a test cuvette, thereby eliminating the previous need for operator intervention. This system thus provides a random access calibration solution supply system with the flexibility to position a large number of different calibration solution containers at aspiration locations by moving calibration solution vials between a calibration solution vial loading tray, at least one calibration solution vial server, and at least one calibration solution aspiration location.

### BRIEF DESCRIPTION OF THE DRAWINGS

The invention will be more fully understood from the following detailed description thereof taken in connection with the accompanying drawings which form a part of this application and in which:

FIG. 1 is a schematic plan view of an automated analyzer adapted to perform the present invention;

FIG. 2 is an enlarged schematic plan view of a portion of the analyzer of FIG. 1;

FIG. 3 is a perspective elevation view of an automated aliquot vessel array storage and handling unit of the analyzer of FIG. 1;

FIG. 4 is perspective elevation view of an aliquot vessel array useful in the analyzer of FIG. 1;

FIG. 5 is a perspective view of a multi-compartment elongate reagent cartridges calibration and control solution vial carrier useful in the analyzer of FIG. 1;

FIG. 5A is a perspective view of a calibration and control solution vial carrier useful in the analyzer of FIG. 1;

FIG. 5B is a top plan view of the calibration and control solutions vial carrier of FIG. 5A;

FIG. 6 is a top plan view of a calibration solution vial management system useful in performing the present invention;

FIG. 7 is a perspective view of a single, bi-directional linear shuttle useful in performing the present invention;

FIG. 8 is a schematic view of a calibration solution aspiration and dispense system useful in performing the present invention; and,

FIG. 9 is a schematic view of the calibration solution aspiration and dispense system of FIG. 8 engaged with calibration and control solution vial carrier of FIG. 5A.

### DETAILED DESCRIPTION OF THE INVENTION

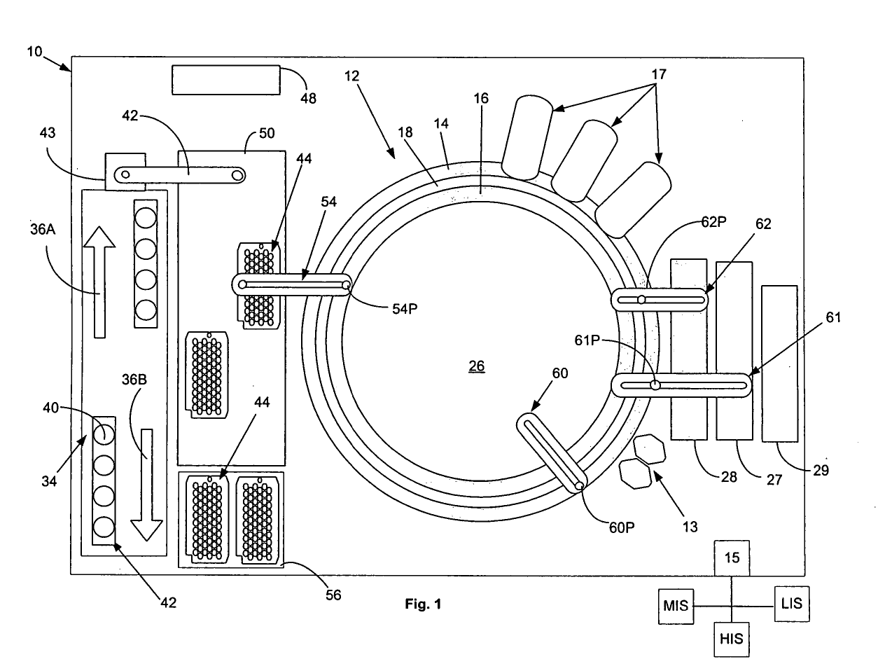

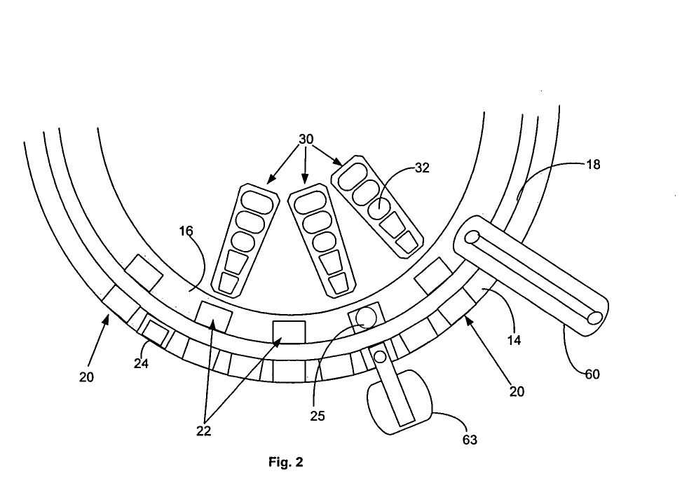

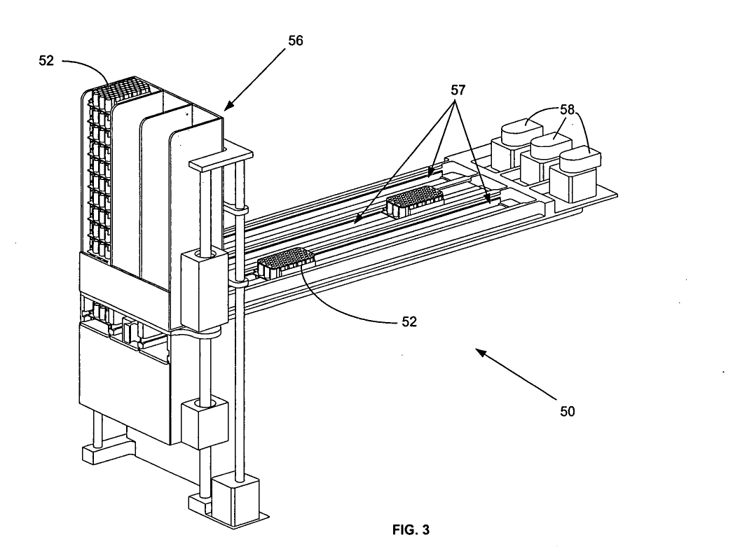

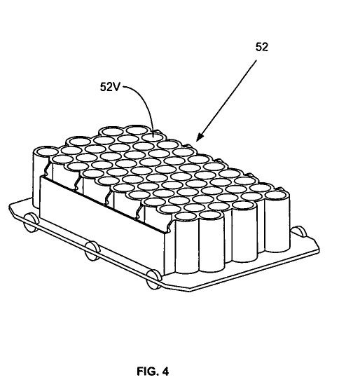

FIG. 1, taken with FIG. 2, shows schematically the elements of an automatic chemical analyzer 10 in which the present invention may be advantageously practiced, analyzer 10 comprising a reaction carousel 12 supporting an outer cuvette carousel 14 having cuvette ports 20 formed therein and an inner cuvette carousel 16 having vessel ports 22 formed therein, the outer cuvette carousel 14 and inner cuvette carousel 16 being separated by a open groove 18. Cuvette ports 20 are adapted to receive a plurality of reaction cuvettes 24 that contain various reagents and sample liquids for conventional clinical and immunoassay assays while vessel ports 22 are adapted to receive a plurality of reaction vessels 25 that contain specialized reagents for ultra-high sensitivity luminescent immunoassays. Reaction carousel 12 is rotatable using stepwise or cyclic movements in a constant direction, the movements being separated by a constant dwell time during which carousel 12 is maintained stationary and computer controlled assay operational devices 13, such as sensors, reagent add stations, mixing stations and the like, operate as needed on an assay mixture contained within a cuvette 24.

Analyzer 10 is controlled by software executed by the computer 15 based on computer programs written in a machine language like that used on the Dimension® clinical chemistry analyzer sold by Dade Behring Inc, of Deerfield, Ill., and widely used by those skilled in the art of computer-based electromechanical control programming. Computer 15 also executes application software programs for performing assays conducted by various analyzing means 17 within analyzer 10.

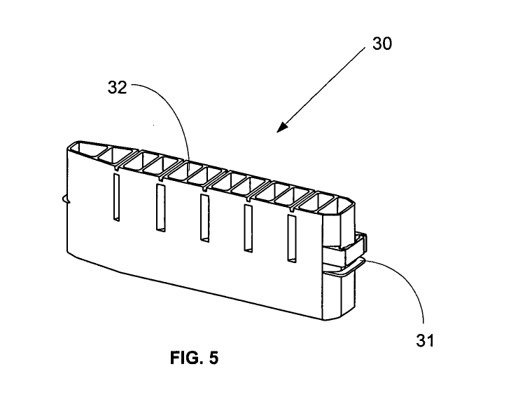

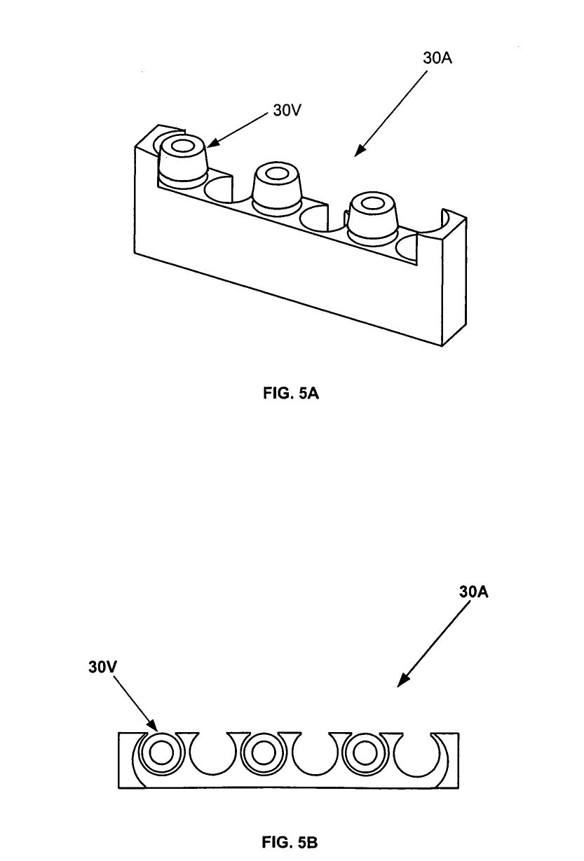

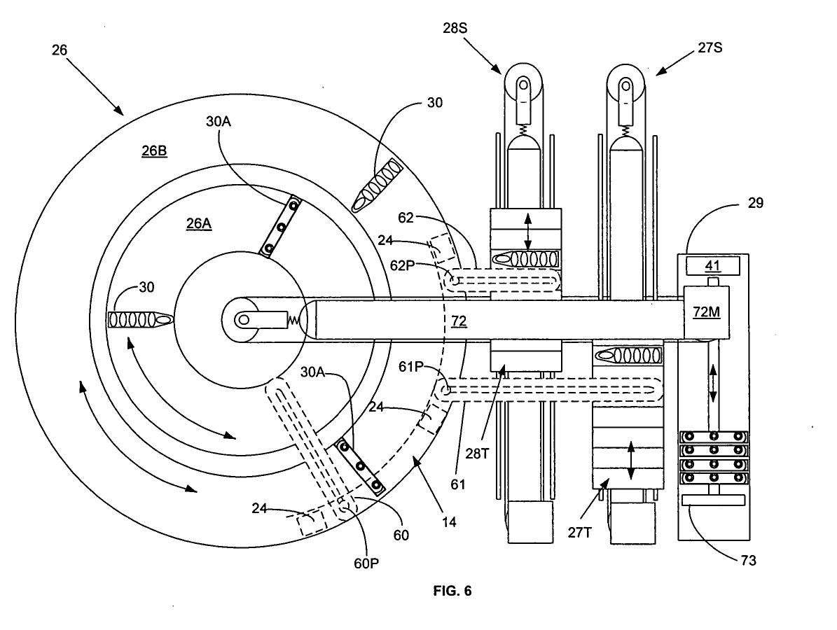

Temperature-controlled storage areas or servers 26, 27 and 28 inventory a plurality of multi-compartment elongate reagent cartridges 30 like that illustrated in FIG. 5 containing reagents in wells 32 as necessary to perform a given assay like described in co-pending application Ser. No. 09/949,132 assigned to the assignee of the present invention. Reagent cartridges 30 are equipped with a sensor mechanism 31 for automatically determining whenever a reagent container 30 is initially placed onto analyzer 10 whether reagent container 30 is new and unused or whether the reagent container 30 has been previously used. Server 26 also inventories calibration solution vial carriers 30A like seen in FIGS. 5A and 5B having calibration or quality control solutions in vials 30V to be used in calibration procedures by analyzer 10 in accord with the present invention. As described later in conjunction with FIG. 6, server 26 comprises a first carousel 26A in which reagent cartridges 30 and vial carriers 30A may be inventoried until translated to second carousel 26B for access by an aspiration and dispense arm 60. FIG. 6 shows an advantageous embodiment in which carousel 26A and carousel 26B are circular and concentric, the first carousel 26A being inwards of the second carousel 26B. Reagent containers 30 and vial carriers 30A may be loaded by an operator by placing such containers 30 or carriers 30A into a loading tray 29 adapted to automatically translate containers 30 and carriers 30A to a shuttling position described later.

A key factor in maintaining an optimum assay throughput within analyzer 10 is the ability to timely resupply reagent containers 30 into servers 26, 27 and 28 before the reagents contained therein become exhausted. Similarly important is the ability to timely resupply calibration solutions in vials 30V into server 26 before the solutions contained therein become exhausted so that calibration and control procedures may be conducted as required, whether this be based on the basis of time between calibrations or number of assays performed since an immediately previous calibration or number of assay results outside normal ranges, or changes in the performance of the analyzer. This challenge may be met by timely equipping analyzer 10 with additional requisite calibration solutions used in calibration and control procedures before they become exhausted, thereby maintaining assay throughput of analyzer 10 uninterrupted.

In order to maintain continuity of assay throughput, and as taught by the present invention, computer 15 is programmed to track reagent and assay chemical solution consumption along with time, and date of consumption of all reagents consumed out of each reagent container 30 and calibration solutions consumed out of each vial container 30A on a per reagent container, per calibration vial container, per quality control container, per assay, and per calibration basis, for specifically defined time periods. Using this consumption data, time, and current inventory data of already on-board reagent containers 30 and calibration vials 30V within storage areas 26, computer 15 is programmed to make an inventory demand analysis for specifically defined time periods so as to determine future assay inventory demands for the specifically defined time periods and display or issue to an operator a list of all of the reagent containers 30 and calibration vials 30V that will be needed in the future in a timely manner prior to the actual need of said reagent container 30 and calibration vials 30V. In some instances, reagents in reagent container 30 must be hydrated or diluted prior to use and such a time factor must also be included in the inventory demand analysis. Addition of said reagent containers 30 and calibration vial carriers 30A by an operator insures sufficient reagent and calibration solution supply to continuously meet future needs of analyzer 10 so that analyzer 10 is maintained in proper operating condition.

It should be appreciated by the reader that making a calibration solution inventory demand analysis for specifically defined time periods, as opposed to using an inventory demand analysis averaged over specifically defined time periods, is a key factor in practicing the present invention. What has been discovered is that the assay demand load pattern and thus the demand pattern for routine calibration and quality control protocols, for example on a Monday, may be very different from the demand pattern, for example on a Thursday. Further, it has been discovered that the demand load pattern, for example on a given day of the week, is most likely going to be very similar to the demand load pattern on the previous several same day of the week. The basis for a specifically defined demand pattern is due to several factors among which are a range of social practices, for example, sporting events typically being on weekends and/or increased social events at holidays and the like. In addition, for reasons of efficiency, some clinical laboratories schedule select assays, for example, PSA tests, on a certain day near middle of the week, and some out-patient tests, for example glucose, are scheduled earlier in the week. Finally, certain surgeons schedule select types of surgery early in the week and other types of surgery near the end of the week, resulting in different daily patterns of pre-operation patient assays. Further contributing to the demand pattern is the fact that different laboratories have different assay demand patterns, depending, for example, upon whether the laboratory serves an urban community where trauma is more likely than in a rural community, upon whether the laboratory serves a medical research university, upon whether the laboratory serves a specialized hospital like a pediatric hospital, and the like.

On a regular basis, for example daily, as taught by the present invention, the calibration and quality control solution consumption data is also transmitted to an external computer system located within a Laboratory Information System (LIS) or Hospital Information System (HIS) or to a Manufacturer Information System (MIS) remotely at the manufacturer of calibration and quality control vials 30A. The external computer systems use the consumption data to determine the need for re-order of vials 30V in a timely manner so as to ensure that the calibration solutions in vials 30V are available in local inventory for future use. In a preferred embodiment of the present invention, the vial 30V consumption data are used by the manufacturer of calibration vials 30V and compared to the manufacture's shipment data to determine re-order quantities. The manufacturer automatically ships additional calibration vials 30V to the location of analyzer 10 as needed to ensure a continuous supply at that location.

A bi-directional incoming and outgoing sample tube transport system 34 having input lane 36A and output lane 36B shown as open arrows transports incoming individual sample tubes 40 containing liquid specimens to be tested and mounted in sample tube racks 42 beneath a liquid sampling aliquotter 38 using a magnetic drive system like described in U.S. Pat. No. 6,571,934 assigned to the assignee of the present invention. Liquid specimens contained in sample tubes 40 are identified by reading bar coded indicia placed thereon using a conventional bar code reader to determine, among other items, a patient's identity, the tests to be performed, if a sample aliquot is to be retained within analyzer 10 and if so, for what period of time. It is also common practice to place bar coded indicia on sample tube racks 42 and employ a large number of bar code readers installed throughout analyzer 10 to ascertain, control and track the location of sample tubes 40 and racks 42.

After a volume of sample fluid is aspirated from all sample fluid tubes 40 on a rack 42 and dispensed into aliquot vessels 44V by sampling aliquotter 38, a rack 42 may be held in a buffer zone until a successful assay result is obtained. Regardless of whether sample fluid racks 42 are held in the sampling zone or buffer zone, shuttle mechanism 43 associated with the buffer zone positions the sample fluid rack 42 onto output lane 36B. Output lane 36B, taken with the magnetic drive system, moves racks 42 containing sample fluid tubes 40 toward the end of the output lane 36B to a frontal area of analyzer 10 which is readily accessible to an operator so that racks 42 may be conveniently unloaded from analyzer 10.

Liquid specimens contained in sample fluid tubes 40 are identified by reading bar coded indicia placed thereon using a conventional bar code reader to determine, among other items, a patient's identity, the tests to be performed, if a sample fluid aliquot is to be retained within analyzer 10 and if so, for what period of time. It is also common practice to place bar coded indicia on sample fluid tube racks 42 and employ a large number of bar code readers installed throughout analyzer 10 to ascertain, control and track the location of sample fluid tubes 40 and sample fluid tube racks 42.

Aliquot vessel array transport system 50 seen in FIG. 6 comprises an aliquot vessel array storage and dispense module 51 and a number of linear drive motors 52 adapted to bi-directionally translate aliquot vessel arrays 44 within a number of aliquot vessel array tracks 57 below a sample fluid aspiration and dispense arm 54 located proximate reaction carousel 12, as seen in FIG. 1. Sample fluid aspiration and dispense arm 54 is controlled by computer 15 and is adapted to aspirate a controlled amount of sample fluid from individual vessels 44V positioned at a sampling location within a track 53 using a conventional liquid probe 54P and then liquid probe 54P is shuttled to a dispensing location where an appropriate amount of aspirated sample fluid is dispensed into one or more cuvettes 24 in cuvette ports 20 for testing by analyzer 10. After sample fluid has been dispensed into reaction cuvettes 24, conventional transfer means move aliquot vessel arrays 44 as required between aliquot vessel array transport system 50, environmental chamber 48 and a disposal area, not shown.

A number of aspiration and dispense arms 60, 61 and 62 comprising conventional liquid probes, 60P, 61P and 62P, respectively, are independently mounted and translatable between servers 26, 27 and 28, respectively and outer cuvette carousel 14. Probes 60P, 61P and 62P comprise conventional mechanisms for aspirating reagents required to conduct specified assays at a reagenting location from wells 32 in an appropriate reagent cartridge 30, the probes 60P, 61P and 62P subsequently being shuttled to a dispensing location where reagent are dispensed into cuvettes 24 contained in cuvette ports 20 in outer cuvette carousel 14. A number of reagent cartridges 30 are inventoried in controlled environmental conditions inside servers 26, 27 and 28. In like manner, a number of calibration solution vials 30V are inventoried in controlled environmental conditions inside server 26, and may be accessed by aspiration and dispense arm 60 as required to conduct calibration and quality control protocols as required to maintain analyzer 10 in proper operating condition. A key factor in maintaining high assay throughput of analyzer 10 is the capability to inventory a large variety of vials 30V having the requisite calibration and control solutions to perform a large number of calibration and quality control protocols inside reagent storage area 26A and 26B and to then quickly transfer random ones of these vials to aspiration and dispense locations for access by probe 60P.

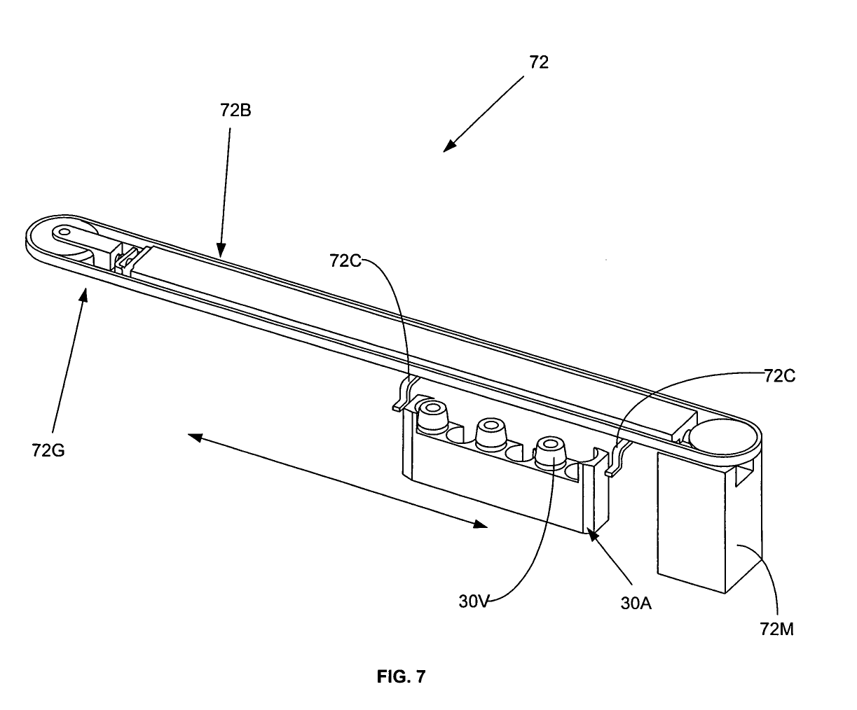

FIG. 6, taken with FIG. 7, illustrates a single, bi-directional linear shuttle 72 adapted to remove vial carriers 30A from loading tray 29 having a motorized rake 73 that automatically locates vial carriers 30A at a loading position beneath shuttle 72. Vials 30V are identified by the type of calibration and control solution contained therein using conventional barcode-like indicia and a bar-code-reader 41 proximate loading tray 29 and are closed with a septum 32S. Computer 15 is programmed to track the location of each and every vial 30V carried in vial carrier 30A as the carrier is transported within analyzer 10. In the instance that reagent container shuttle 72 is transferring a single vial carrier 30A, as seen in FIG. 7, shuttle 72 comprises an automated tensioner 72G like described in co-pending U.S. Pat. Ser. No. 10/623,311 and assigned to the assignee of the present invention and designed to compensate for changes in length a shuttling drivebelt 72B may experience during use or for changes in tension the drivebelt 72B may experience during abrupt reversals of direction so that vial carriers 30A may be precisely positioned at their intended location as the drivebelt 72B wears. In use of tensioner 72G, a motor 72M is controlled by computer 15 to circulate drivebelt 72B in clockwise and counter-clockwise directions in order to position vial carriers 30A within slots in carousel 26. In FIG. 7, drivebelt 72B has vial carrier 30A attached thereto by means of edge guides 72C so that vial carrier 30A containing vials 30V of calibration or quality control liquids may be shuttled bi-directionally along the direction indicated by the double-headed arrow. Shuttle 72 is thereby adapted to dispose a vial carrier 30A into slots within server 26 and to dispose such vial carriers 30A into either of two concentric carousels 26A and 26B within server 26. Shuttle 72 is also adapted to move vial carriers 30A between the two concentric carousels 26A and 26B. As indicated by the double-headed arc-shaped arrows, carousel 26A may be rotated in both directions so as to place any particular one of the vial carriers 30A disposed thereon beneath reagent aspiration arm 60.

Reagent container shuttles 27S and 28S in FIG. 6 are similar in design to carrier shuttle 72 seen in FIG. 7. Reagent aspiration arms 60, 61 and 62 are shown in dashed lines to indicate that they are positioned above the surfaces of reagent containers 30 inventoried in carousel 26B, and reagent container trays 27T and 28T, respectively. From this description, it is clear that shuttle 72 may also move reagent containers 30 between reagent container loading tray 29, reagent container trays 27T and 28T, and carousels 26A and 26B; in addition shuttles 27S and 28S may move reagent containers 30 in reagent container trays 27T and 28T to appropriate aspiration locations (or to a loading location beneath shuttle 72) and reagent carousels 26A and 26B may place any reagent container 30 beneath reagent aspiration arm 60, providing a random access reagent supply system.

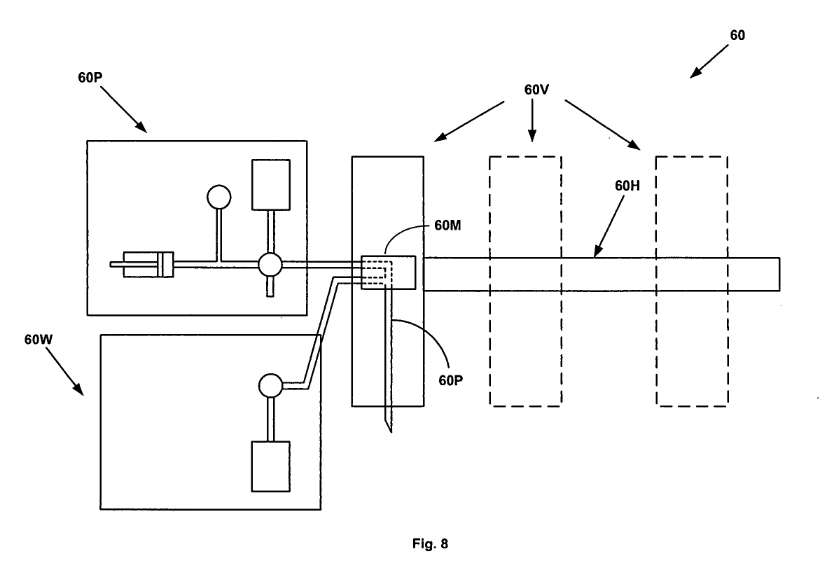

Aspiration and dispense arm 60 and probe 60P useful in performing the present invention may be seen in FIG. 8 as comprising a Horizontal Drive component 60H, a Vertical Drive component 60V, a Wash Module component 60W, and a Wash Manifold component 60M having the primary functions described in Table 1. Horizontal Drive component 60H and Vertical Drive component 60V are typically computer controlled stepper motors or linear actuators and are controlled by computer 15 for providing precisely controlled movements of the Horizontal Drive component 60H and Vertical Drive component 60V.

TABLE 1

| Module | Primary Functions |
|---|---|
| Horizontal Drive | Position the Vertical Drive 60V over vials 30V |
| 60H | containing calibration or quality control |
| | liquids and carried in a vial carrier 30A and |
| | over cuvettes 24 carried in ports 20 in |
| | carousel 14. |
| Vertical Drive | Drive probe 60P through the septum 30S of a |
| 60V | vial 30V. |
| Wash Module | Remove contamination from probe 60P with |
| 60W | liquid cleansing solutions |
| Wash Manifold | Connect probe 60P to Pump Module 60P |
| 60M | |
| Probe 60P | Aspirate and dispense calibration or quality |
| | control liquids and sample fluids |

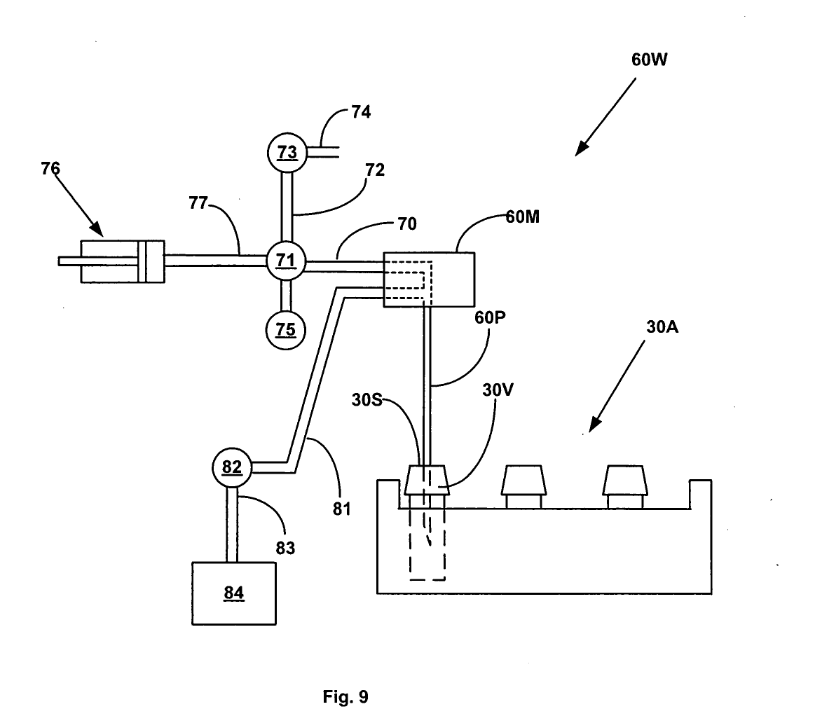

FIG. 9 shows probe 60P as a conventional hollow, liquid-carrying bore having conventionally defined interior and exterior surfaces and supported by Wash Manifold 60M, the Wash Manifold 60M being connected by a hollow air tube 70 to a three-way valve 71. Probe 60P preferably has a tapered point designed to reduce friction when inserted through septum 30S and may be connected to Wash Manifold 60M using any of several screw-like connectors, not shown, or alternately, permanently welded thereto. Valve 71 is operable to optionally connect air tube 70 to (1) a vent valve 73 connected to an atmospheric vent tube 74 and an air supply 75, or to (2) a piston-type syringe pump 76 by a hollow air tube 77. A conventional air pressure measuring transducer 78 is connected to air tube 77 between pump 76 and valve 71 by a hollow air tube 79.

FIG. 9 illustrates probe 60P having punctured septum 30S of a vial 30V and positioned within a calibration or quality control liquid contained therein. Level sensing means, for example using well known capacitive signals, are may be advantageously employed in order to ensure that probe 60P is in fluid communication with the liquid. Piston 76 is activated and the distance it is moved is controlled by computer 15 so that a controlled volume of calibration or quality control liquid is withdrawn or aspirated into probe 60P. During this process, valve 71 is closed to vent tube 72, but is open to air tube 77 and air tube 70. Valve 71 is operable to optionally connect air tube 70 to a vent valve 73 connected to an atmospheric vent tube 74. After aspiration of calibration or quality control liquid from vial 30V is completed, Wash Manifold 60M is raised by Vertical Drive 60V and positioned by Horizontal Drive 60H so that probe 60P may dispense calibration or quality control liquid into a cuvette 24 carried in port 20 in carousel 14. FIG. 9 also shows Wash Manifold 60W as comprising a flush valve 82 connected to Wash Manifold 60W by a hollow liquid carrying tube 81. Flush valve 82 is operable to connect liquid carrying tube 81 to a pressurized rinse water source 84 by a hollow liquid tube 83.

From this description, it is clear to one skilled in the art that the capabilities of shuttle 72 to move vial carriers 30A between loading tray 29 and servers 26A and 26B, taken in combination with the capabilities of carousels 26A and 26B to place any vial carrier 30A beneath aspiration arm 60, and the capabilities of aspiration and dispense arm 60 and probe 60P to access liquid solutions from closed vials 30V provide a random access vial carrier 30A supply system with the flexibility to deliver a large number of different calibration solutions into cuvettes 24 as needed to automatically perform calibration protocols and make adjustments as required to maintain the analyzer in a proper and accurate analyzing condition without need for operator intervention.

It should be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention.

Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

1. A biochemical analyzer adapted to automatically self-perform calibration and quality control protocols thereon, the analyzer comprising:
an inventory of calibration solution vials on board said analyzer carried in a number of calibration vial carriers, said vials closed with a closure;
an automatic shuttle for moving any one of said vials to an aspiration location;
a probe adapted to automatically penetrate the closure closing said vials;
aspiration means for aspirating a predetermined amount of solution therefrom and to dispense said solution into a test cuvette.

2. The analyzer of claim 1 wherein calibration and control procedures are automatically conducted on the basis of time lapse between calibrations or on the number of assays performed since an immediately previous calibration or number of assay results outside normal ranges.

3. The analyzer of claim 1 further adapted to track calibration solution consumption along with time, and date of consumption of all liquids consumed out of each vial on a per vial basis for specifically defined time periods.

4. The analyzer of claim 1 wherein the vials are inventoried inside controlled environmental servers and may be accessed by aspiration and dispense arms to conduct calibration protocols as required to maintain analyzer in proper operating condition.

5. The analyzer of claim 2 wherein the shuttle is a bi-directional linear shuttle adapted to position different vials at different locations within said analyzer by moving the vials between a loading tray, at least one server, and at least one carousel.

6. The analyzer of claim 3 wherein the loading tray includes a motorized rake adapted to automatically position the vials beneath the linear shuttle.

7. The analyzer of claim 4 having first and second concentric carousels, the first carousel being inwards of the second carousel, the linear shuttle adapted to move vials between the first and second concentric reagent carousels.

8. The analyzer of claim 5 further comprising a reaction carousel having cuvette ports formed therein to receive a plurality of reaction cuvettes, the aspiration and dispense arms operable to aspirate calibration solution from vials in the carousel and to dispense calibration solution into the reaction cuvettes.
